(19) United States
(12) Patent Application Publication
(10) Pub. No.: US 2010/0300276 A1
(43) Pub. Date: Dec. 2, 2010

(54) HIGH-PERFORMANCE BULLETPROOF GLAZING

(75) Inventor: Guillaume Justamon, Adon (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Saint-Gobain Glass France, Courbevoie (FR)

(21) Appl. No.: 12/676,835

(22) PCT Filed: Sep. 5, 2008
(86) PCT No.: PCT/FR08/51582

§ 371 Date: Mar. 5, 2010

(30) Foreign Application Priority Data
Sep. 7, 2007 (FR) 0757425

(51) Int. Cl. F41H 5/02; B32B 3/00; B32B 37/12

(52) U.S. Cl. 89/36.02; 428/77; 156/60; 89/905

(57) ABSTRACT

A transparent laminated bulletproof and/or splinter-proof structure comprising three stacks of glass sheets (a, c; e, g, i; k) all connected together by adhesive interlayers (b, d, f, h, j), in which
the first stack (a, c) is adjacent to and protrudes from the second stack (e, g, i), which is itself adjacent to and protrudes from the third stack (k),
a liner (q, s, u) made of bulletproof and/or splinter-proof material is bonded to the laminated structure on the free peripheral surface of the first stack (a, c), the edge and the free peripheral surface of the second stack (e, g, i) and the edge of the third stack (k),
and a transparent plastic sheet (m) is bonded to the liner (u) and to the free face of the third stack (k).

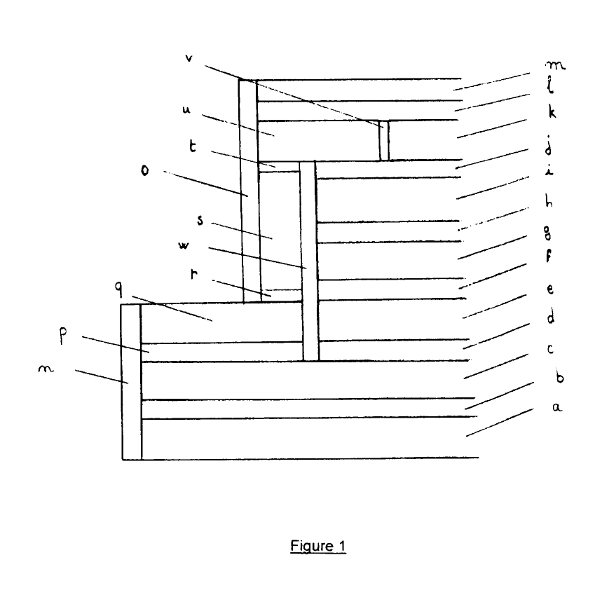

A manufacturing process, the application of this laminated structure, and a glazing comprising it.

The present invention relates to glazing that is resistant to bullets and/or splinters and/or similar projectiles.

The ballistic resistance is understood here for levels as high as BR 3, BR 4, BR 5, BR 6 and BR 7 of French standard FR EN 1063.

In the glazing zones sufficiently distant from the sides, the ballistic resistance depends on the glass composition (number and thickness of glass sheets). This composition is therefore defined on an individual basis, according to the level of protection required.

In the glazing edge region, two independent mechanisms must be taken into account.

First, the impacts of hardcore bullets (called armor piercing bullets) are characterized by the fact that the core or the core fragments always take the ballistic path of least energy expenditure, and hence where the local resistance of the material is the weakest. In bullet resistant glazings, the weakest zones, such as the joints between pieces or sides of the glass laps, are ballistic attraction points.

According to the second mechanism, during incident impacts (firing angle to the normal of the bullet resistant glazing), the bullet always advances in the glass while increasing the angle of incidence by ricochet effect. The ricochet effect is combined with the effect of the ballistic attraction points, defining the trajectory of the bullet in the thickness of the glazing.

Furthermore, bullet resistant glazings comprise a sheet of non-brittle organic material on the back, having elastoplastic behavior under high speed ballistic impacts, such as polycarbonate. This back provides optimal ballistic efficiency when it can be deformed isotropically to form a “dome” or “bulb”.

The nearness of the sides of this sheet is a factor that may reduce the ballistic performance of the glazing.

It is the object of the present invention to substantially improve the ballistic resistance of the glazing.

This resistance is needed on the interior of the glazing, and can be provided by a polycarbonate sheet, on the offset of part of the periphery—consisting for example of the free surface of a metal liner—and on the edge of the ballistic block—consisting for example of a tape maintaining the adhesion of the polycarbonate and the metal liners.

Furthermore, the shape of the glazing, in particular in its peripheral portion, must be adapted to the mounting for which it is intended. Thus, the thickness of the offset may be wisely adapted to be introduced into the rebate of a car body.

It is also important, particularly in the case of sliding glazing, that the sliding surfaces of the glazing do not have any asperities, with any protuberances preventing the sliding of the glazing in the door seal, for example.

These objectives are achieved by the invention which relates to a transparent laminated bulletproof and/or splinter-proof structure comprising three stacks of glass sheets all connected together by adhesive interlayers, characterized in that in at least part of the periphery of the laminated structure, the first stack is adjacent to and protrudes from the second stack, which is itself adjacent to and protrudes from the third stack, in that a liner made of bulletproof and/or splinter-proof material is bonded to the laminated structure on the free peripheral surface of the first stack, the edge and the free peripheral surface of the second stack and the edge of the third stack, and in that a transparent plastic sheet suitable for absorbing energy is bonded to the liner and to the free face of the third stack.

In the context of the invention glass essentially means a mineral glass such as a silico-sodo-calcic float glass, but also a rigid transparent plastic of the acrylic (polymethylmethacrylate), polycarbonate, ionomer resin type, etc.

If said second stack is thicker than the liner, it may be shaped in three parts, possibly a “Z” shape.

In the opposite case, the liner may have a shape in two parallel parts, obtained by eliminating the central branch of the Z.

The laminated structure is intended to be mounted in such a way that the potential impact occurs on the side of said first stack.

According to the invention, the most vulnerable region consists of the adhesive joining the liner to the edge of said third stack.

Thanks to the invention, this vulnerable region is at once smaller and as far as possible from the impact zone, so that only the lowest energy non-vulnerant core fragments reach it.

The invention consists in using metal liners—or equivalent—to border the offset side zone of the glazing, in order to secure the most brittle ballistic attraction zone (more brittle material at the side of the glass lap).

Thus the vulnerant fragments deviated in the zone bordered by the liner would necessarily be stopped by it, in particular by its part farthest from the impact.

The fragments unaffected by the edge effect, not attracted by this attraction zone, are stopped by the glass composition alone. Finally, the only vulnerant fragments which have any probability of reaching the critical zone of the joint between the liner and the edge of the third stack have necessarily been deviated due to the attraction of the edge zone, and therefore have had to pass through a higher glass thickness than the undeviated shots on the glass/glass zone. In consequence, they are less vulnerant, and will strike the final polycarbonate barrier.

Moreover, thanks to the invention, an optimal efficiency of the deformed polycarbonate sheet is preserved by preserving an edge zone protected by the liner and not shattered by the impact, which provides a reliable support surface to enable the polycarbonate to be deformed into a bulb. The ballistic steel liner must also maintain the rigidity of the glass assembly after the first impact and force the polycarbonate to work optimally and absorb the maximum of energy.

Furthermore, the edge of the liner adjoins the edge of said third stack. Passage through the autoclave incurs risks of breakage by cleavage of the glass lap (flakes) upon contact with a metal liner by thermomechanical effect. The present invention allows the use of a bumper scotch with a 0.38 mm one-sided polyurethane adhesive. For the ballistic strength of the glazing, it is important for this bumper to be as thin and as rigid as possible.

The liner is joined to the free peripheral surface of said first stack in particular by the use of a double-sided adhesive foam tape during passage through the autoclave, or by finishing bonding outside the autoclave on the already laminated glazing. The adhesive used may be acrylic, polyurethane, etc., provided that it procures very good adhesive resistance upon the impact of a bullet, the durability required in the conditions of use (automotive, etc.), an ability to compensate for differences in shape between parts thanks to its foam texture, for example.

The bulletproof and/or splinter-proof material of the liner may be metallic (steel, etc.) or made of a composite of plastic and reinforcing fibers (glass, aramid, etc.).

The liner is:
either in a single piece,
or in several parts joined by adhesive (polyurethane, acrylic, etc.).

In a particular embodiment, in said at least part of the periphery of the laminated structure, at least one glass sheet of said second stack protrudes from at least one other glass sheet of said second stack, and the liner penetrates into the edges of said at least one glass sheet protruding from said second stack. In this case, it is also conceivable that the liner is also penetrating with regard to said third stack.

Said at least part of the periphery of the laminated structure preferably comprises the upper side and the two lateral sides thereof. Thus, in a common embodiment, three of the four sides of a quadrilateral are ballistically reinforced according to the invention.

Advantageously, the free faces of the laminated structure are flush. The advantages are associated with the ease of assembly, the aerodynamics, and the possibility of sliding in the case of mobile (sliding) glazing.

In a preferred embodiment, in said at least part of the laminated structure, the adhesion of the liner and said plastic sheet is maintained by a tape which covers the free edges of the assembly. This tape consists for example of the combination of thermoplastic polyurethane adhesive and an encapsulation polyurethane, which does not soften at the assembly temperatures in the autoclave, but at a temperature of about 180° C. The hardness of the encapsulation PU is about 85±5 Shore A for example. The combination of the two PUs thus combines both a rigidity in order to correct the alignment defects of the components of the laminated structure, and a flexibility to adapt to this lack of alignment. The thermoplastic PU provides the bonding of the encapsulation PU with the liner on the one hand, and with the edge of the plastic sheet on the other hand.

The tape is also resistant to the shear to which it is subjected by the underlying components, particularly in case of impact. It thus performs the splinter-proof function.

An equivalent tape can be bonded to the edge of said first stack and of the liner.

The invention further relates to a method for fabricating a laminated structure described above, characterized in that it comprises
assembling the glass block followed by passage through the autoclave at 140-150° C.,
bonding the liner by adhesives, assembling the plastic sheet by means of an adhesive layer, followed by passage through the autoclave at 105-115° C. under a pressure up to 8 bar.

Other objects of the invention are
a glazing for buildings or transport vehicles, in particular automotive, such as windshield, fixed or mobile side window or rear window, comprising a laminated structure previously described;
the application of such a laminated structure to stop three shots of type 7.62×51 P80 armor piercing bullets, defined by
   impact points that are aligned and spaced in pairs by 120 mm, in the zone of said at least part of the periphery of the laminated structure, the point of the first impact being midway between the other two,
   bullet speeds of 820±10 m/s, and by
   firing angles situated in a cone of 20° to the normal of the laminated structure.

The invention will be better understood in light of the example that follows with reference to the single FIGURE appended, schematically showing a cross section of a laminated structure according to the invention.

The table below gives the composition of all the components of a laminated structure according to the invention, their dimensions, and, for some of these dimensions, the ranges suitable for various feasible applications.

TABLE

| | Dimensions | | |
|---|---|---|---|
| References | (mm) | Dimensional ranges (mm) | Description |
| a | 8 | | Glass |
| b | 1.52 | | PVB |
| c | 8 | | Glass |
| d | 0.76 | | PVB |
| e | 10 | | Glass |
| f | 0.76 | | PVB |
| g | 10 | | Glass |
| h | 0.76 | | PVB |
| i | 10 | | Glass |
| j | 0.76 | | PVB |
| k | 6 | 6 max/no min | Glass |
| l | 1.9 | 0.38 to 3 | TPU |
| m | 2.5 | 0.5 to 4 | PC varnish |
| n | 1 | 1 to 3 | PPN (TPU) |
| o | 1 | 1 to 3 | PPN (TPU) |
| p | 2.2 | 1.1 to 3.3 | VHB 4947 |
| q | 7 (th.) × 30 | [1 to 9] × [0 to 200] | Ballistic |
| | (offset) | (variable according to | steel |
| | | ballistic | |
| | | specification) | |
| r | 0.38 | 0.38 to 3 | TPU |
| s | 7 (th.) × 23 | [1 to 9] × [0 to 100] | Ballistic |
| | | (variable according to | steel |
| | | ballistic | |
| | | specification) | |
| t | 0.38 | 0.38 to 3 | TPU |
| u | 5 (th.) × 30 | [1 to 9] × [5 to 50] | Ballistic |
| | | (variable according to | steel |
| | | ballistic | |
| | | specification) | |
| v | 0.38 | 0.38 to 3 | TPU |
| w | 1.9 | Min 0.38 | PU |
| x | 1.9 | Min 0.38 | PU |

The abbreviations in the table have the following meanings:
PVB=polyvinylbutyral
TPU=thermoplastic polyurethane
PC varnish=polycarbonate coated with anti-scratch varnish
PPN (TPU)=tape of encapsulation polyurethane combined with thermoplastic polyurethane, described above
VHB 4947: double-sided VHB acrylic foam tape, sold under this reference by 3M
PU=polyurethane

The method for manufacturing this laminated structure is now described.

The glass block a, b, c, d, e, f, g, h, i, j, k, is assembled and then introduced into the autoclave at 145° C.

The liner q is pre-bonded by the double-sided VHB acrylic foam p.

The liners s and u are then joined by the interlayer adhesives r, w, t, v.

l, m, n and o are assembled and the assembly then introduced into the autoclave at 110° C. under a pressure up to 8 bar.

The laminated structure obtained resists all shots performed as follows:
laminated structure: specimen 500×200 mm;
three shots of armor piercing bullets 7.62×51 P80;
impact points that are aligned and spaced in pairs by 120 mm in the peripheral zone according to the glazing invention;
the point of the first impact being midway between the other two;
speed 820±10 m/s;
firing angles situated in a cone of 20° to the normal of the laminated structure.

A glazing that is different from that of the invention by the fact that the liner q is penetrating, and by the absence of the liners s and u, is perforated by the second impact in more than 50% of cases.

1. A transparent laminated structure comprising three stacks of glass sheets all connected together by adhesive interlayers,
wherein at least part of the periphery of the laminated structure, the first stack is adjacent to and protrudes from the second stack, which is itself adjacent to and protrudes from the third stack,
in that a liner made of bulletproof and/of and splinter-proof material, or both, is bonded to the laminated structure on the free peripheral surface of the first stack, the edge and the free peripheral surface of the second stack and the edge of the third stack,
and wherein a transparent plastic sheet suitable for absorbing energy is bonded to the liner and to the free face of the third stack.

2. The laminated structure as claimed in claim 1, wherein the liner is in one piece.

3. The laminated structure as claimed in claim 1, wherein the liner is made of several parts joined by adhesive.

4. The laminated structure as claimed in claim 1, wherein in said at least part of the periphery of the laminated structure, at least one glass sheet of said second stack protrudes from at least one other glass sheet of said second stack, and in that the liner penetrates into the edges of said at least one glass sheet protruding from said second stack.

5. The laminated structure as claimed in claim 1, wherein said at least part of the periphery of the laminated structure comprises the upper side and the two lateral sides thereof.

6. The laminated structure as claimed in claim 1, wherein its free faces are flush.

7. The laminated structure as claimed in claim 1, wherein in said at least part of the laminated structure, the adhesion of the liner and the plastic sheet is maintained by a tape which covers its free edges.

8. A method for fabricating a laminated structure as claimed in claim 1, comprising
assembling the glass block followed by passage through the autoclave at 140-150° C.,
bonding the liner with an adhesive layer, assembling the plastic sheet by means of an adhesive layer, followed by passage through the autoclave at 105-115° C. under a pressure up to 8 bar.

9. A glazing for buildings or transport vehicles, comprising a laminated structure as claimed in claim 1.

10. A method of stopping a shot of type 7.62×51 P80 armor piercing bullets, comprising stopping said shot with a laminated structure as claimed in claim 1, defined by
impact points that are aligned and spaced in pairs by 120 mm, in the zone of said at least part of the periphery of the laminated structure, the point of the first impact being midway between the other two,
bullet speeds of 820±10 m/s, and by
firing angles situated in a cone of 20° to the normal of the laminated structure.
